(19) United States
(12) Patent Application Publication
(10) Pub. No.: US 2026/0334449 A1
(43) Pub. Date: Oct. 29, 2026

(54) DEVICE TO ATTRACT, CAPTURE AND/OR KILL MOSQUITOES AND/OR BITING INSECTS, METHOD FOR ASSEMBLING AND USING A DEVICE AND USE OF A DEVICE

(71) Applicants: Patrick GUERIN, Fleurier (CH); Balázs BERNÁTH, Budapest (HU)

(72) Inventors: Patrick GUERIN, Fleurier (CH); Balázs BERNÁTH, Budapest (HU)

(21) Appl. No.: 19/107,834

(22) PCT Filed: Sep. 1, 2022
(86) PCT No.: PCT/EP2022/074352

§ 371 Date: Feb. 28, 2025

(51) Int. Cl. A01M 1/04; A01M 1/10; A01M 1/20

(52) U.S. Cl. CPC A01M 1/04; A01M 1/106; A01M 1/2044

(57) ABSTRACT

Devices to kill and/or capture mosquitoes and other biting insects are disclosed comprising a container with a bottom surface, a side wall with inner and outer lateral surfaces and with an upper rim that allows said container to contain liquid and emit moisture, wherein said container is equipped with at least one solid and at least partially curved, especially convex, light polarizing element producing horizontally polarized light.

### CROSS-REFERENCE TO RELATED APPLICATIONS

This application claims priority from PCT/EP 2022/074352, filed Sep. 1, 2022, the disclosure of which is hereby incorporated herein in its entirety by reference.

### FIELD

The present invention relates to a device to attract, capture and/or kill mosquitoes and other biting insects, a method for assembling and using a device and the use of a device according to the characteristics of the preambles in independent claims.

### BACKGROUND

Mosquitoes are members of the insect order Diptera that contains some of the most notorious biting insects that serve as vectors of disease. Biting insects comprise mosquitoes, sandflies, tsetse flies, black flies, tabanid horse and deer flies, stable flies, horn flies and other members of the genus Haematobia and snipe flies. During blood-feeding, biting insects may transmit parasites such as malaria, trypanosomiasis, surra, leishmaniasis, onchocerciasis, filariasis and loiasis and infectious agents such as dengue virus, yellow fever virus, Zika virus, West Nile virus, chikungunya, plague, Bacillus anthracis, Bluetongue virus and lumpy skin disease virus into humans and host animals as for example into domesticated farm animals. The transmissions of malaria, yellow fever, dengue fever, West-Nile Virus and filiariasis are linked to bites of mosquitoes, sand flies are responsible for the transmission of leishmaniasis, tsetse and horseflies transmit trypanosomes to animals and man, while myiasis fly maggots feed on living flesh. Control of mosquitoes is of particular significance in tropical regions. Mosquito-transmitted malaria alone kills more than 600,000 people in the world annually, the vast majority of them children under the age of 5. Another 500,000 people are hospitalized with potentially fatal severe dengue fever every year. In remote rural areas of sub-Saharan Africa tsetse flies and the trypanosome parasites they transmit affect both animals and man, thus depriving large parts of Africa of agriculture as we know it in temperate zones.

Incidences of mosquito-transmitted diseases are much less serious in Europe, but do exist, and predictably will increase economic and health risks in the coming decades. The return of malaria to Greece alarms European health organizations. In addition, on-going increases in temperature, increased tourism and accelerated global transportation systems permit invasive tropical and subtropical insect vector species and their associated pathogens to spread north. Today the most visible threat in Europe is that posed by the Asian tiger mosquito, a competent vector of dengue and the Zika virus. This species has been detected in more than 20 western European countries with established populations in 9 countries bordering the northern Mediterranean and has already caused local outbreaks of chikungunya in Italy. The tiger mosquito has a particular advantage in urban areas due to its capacity to exploit habitats afforded by artificial water containers.

The key to suppressing insect-transmitted diseases is continuous monitoring of the disease situation and elimination of the insect vectors. From the 1950's synthetic insecticides were used with great success, but now even more modern and less dangerous chemicals used for vector control are to be gradually abandoned due to concerns regarding human health hazards, negative effects on beneficial organisms and development of resistance against insecticides in the targeted insect species. Modern bio-insecticides such as the toxin of the soil-dwelling bacterium Bacillus thuringiensis provide effective tools for mosquito control in the field but must be precisely targeted and applied in a timely manner.

Mosquito species are adapted to various light conditions ranging from bright daylight to starlit nights, suggesting significant heterogeneity in their visual capabilities. Gravid female mosquitoes are those that produce eggs after a successful blood meal. These females are not attracted to hosts, but search for appropriate habitats for their larval offspring on or near water (Himeidan et al., 2013). Most mosquito species such as Aedes spp., Culex spp., Toxorhynchites spp. are attracted to darker surfaces. It is also known that intense illumination tends to prevent females from laying eggs.

A strong case has been made by Johnson et al. (2017) for the use of water-filled cylindrical containers laced with insecticide for cost-effective control of the tiger mosquito in temperate zones of the planet in an effort to stem arboviral epidemics in human populations. Furthermore, since most pathogens need incubation periods of several days within the mosquito before it becomes infective when the mosquito bites, sufficiently effective traps for gravid female mosquitoes would have the potential to break infection cycles locally through significantly decreased vector population densities. Monitoring the abundance of mosquitoes, information on disease transmission rates and on the appearance of pathogens in previously uninfected mosquito populations can also be provided by traps designed to capture mosquitoes and to collect their eggs.

Description of the above-mentioned facts can be found in the following references:

Himeidan, Y. E., Temu, E. A., Rayah EAE et al. (2013) Chemical Cues for Malaria Vectors Oviposition Site Selection: Challenges and Opportunities. Journal of Insects, Article ID 685182, http://dx.doi.org/10.1155/2013/685182.

Johnson, B. J., Ritchie S, A. and Fonseca, D. M. (2017) The state of the art of lethal oviposition trap-based mass interventions for arboviral control. Insects, 8, 5; doi:10.3390/insects8010005.

### SUMMARY

The aim of the present invention is to provide an alternative to existing methods designed to reduce the effects of insect vectors of disease, particularly mosquitoes and other biting insects, on populations of host animals and man through their biting activities and their capacity to transmit parasites and infectious agents.

An additional aim of the present invention is to provide an alternative to existing methods to efficiently monitor populations of insect vectors of disease, particularly mosquitoes and other biting insects, so as to guide public health interventions in insect vector control.

Another aim of the present invention is to provide an alternative to existing methods to control populations of insect vectors of disease, particularly mosquitoes, in order to limit population growth of the insect vectors of disease and thereby limit the capacity of mosquitoes and other biting insects to transmit parasites and/or pathogens onto host animals and man.

According to this invention these aims are achieved through the object of the claims, particularly the independent claims, especially by a device to attract, capture and/or kill mosquitoes and other biting insects, a method for assembling and using a device and the use of a device according to the characteristics of the preambles in independent claims.

Sunlight is a primary carrier of information in ecosystems on earth. Scattering and interference of light, and both diffuse and specular reflection of light produce rich light patterns that are analysed by remarkably multitudinous eye types in insects. While humans see only colour and intensity, insect eyes also perceive the linear polarization of light, which is the arrangement of the electric vector of the electromagnetic wave to a specific plane perpendicular to the direction of propagation. The orientation of this specific plane defines the direction of linear polarization, while the level of arrangement defines the degree of linear polarization of light.

According to the Fresnel formulae, reflection of light by the surface of a dielectric material results in partial linear polarization, the direction of polarization being parallel to the reflecting surface. The darker the reflecting material the higher the net degree of linear polarization of reflected light.

Partially horizontally polarized light reflected by liquid surfaces, which are of interest to mosquitoes as places to lay eggs, forms one of the most striking natural polarization patterns. This is in sharp contrast with the diffuse polarization pattern of the surrounding vegetation.

The neuroanatomical basis for polarization sensitivity of dipteran insect eyes, including mosquitoes, is provided by the orthogonally directed microvilli of retinula cells 7 and 8, which are arranged vertically in tandem in the centre of each ommatidial subsection of the insect's compound eye, and have separate second-order neuronal channels to the brain of the insect.

The inventors demonstrate how horizontally polarized light attracts mosquitoes.

The inventors further demonstrate how horizontally polarized light attracts mosquitoes in a defined physiological state in that egg-laying mosquitoes, also called gravid mosquitoes, respond to horizontally polarized light whereas non-gravid mosquitoes do not.

Further, the inventors demonstrate how presence of moisture, i.e., water vapour, is necessary to attract egg-laying mosquitoes to horizontally polarized light.

The inventors show how a device according to the present invention, the device comprising a container equipped with at least one solid light polarizing element, selectively attracts mosquitoes of a defined physiological state.

Existing trapping devices for mosquitoes are not designed to attract egg-laying females with an optimised pre-defined combination of stimuli that includes horizontally polarized light. The subject of this invention is a device designed to overcome this deficiency.

The invention is a device to attract, capture and/or kill mosquitoes and other biting insects. The term biting insects used here means those insect species that bite man and animals, and also plant-biting insect species.

The device comprises a container, which container comprises a bottom, especially a bottom surface, and a side wall comprising an inner lateral surface and an outer lateral surface. Furthermore, the container comprises a rim defining an aperture, which is especially defined as the upper rim of the container to the open and upper side of the container. Herein the area of the upper opening is defined as the area surrounded by the upper rim.

The container is designed to release and/or emit moisture.

In order to release moisture, the container can be at least partially filled with a liquid, which liquid is selected from water or a water solution or any other suitable liquid. The liquid in the container my comprise a mixture of water and hay (dried grass) to attract egg-laying mosquitoes. The surface of the liquid, especially water, in the container is exposed to the air in order to produce high local relative humidity through evaporation of the liquid.

Alternatively, a sponge structure or the like can be arranged within the container, via which structure the moisture is slowly released from a reservoir or the like. The container can also be equipped with any other suitable moisture emitter.

Furthermore, the container is equipped with at least one solid light polarizing element producing horizontally polarized light, which at least one light polarizing element is at least partially curved, especially convex.

The curvature of the light polarizing element may be in one dimension such as in the case of a portion of a cylinder or may be in two dimensions such as in the case of a portion of a sphere.

According to one embodiment of the invention, the at least one light polarizing element is designed in the form of a saucer dome, especially constituting a segment of a sphere.

In a preferred device, the at least one light polarizing element is located over the upper rim of the container. In a preferred device the polarizing element, especially in the form of a saucer-dome, protrudes over the upper rim of the container and prevents rain water from entering the device. Especially the part of the least one light polarizing element, which part is protruding over the upper rim of the container, covers an area which is bigger than an area covered by an upper opening of the container.

When the container is used to attract and/or catch and kill biting insects such as mosquitoes the polarizing element completely covers the opening surrounded by the upper rim of the container, wherein a liquid at least partially fills the inside of the container.

Alternatively, the at least one light polarizing element is held or anchored or sits freely on the bottom surface of the container, which container is at least partially filled with a liquid and wherein the at least one light polarizing element is partially immersed in the liquid within the container and which at least one light polarizing element partially protrudes above the upper rim of the container.

According to one embodiment, the surface of one of the at least one light polarizing element is pierced with one or more holes over its surface to vent air.

In an embodiment with the light polarizing element being partially immersed in a liquid within the container-as will be described in more detail further below-the surface of the at least one light polarizing element is pierced with at least one hole within a part of the surface, which part is located over the liquid to vent air within the device.

According to one embodiment a solid light polarizing element is present on the inner lateral surface of the container and another polarizing element is present on the outer lateral surface of the container, wherein said inner and outer polarizer elements may be portions of a single solid light polarizing material.

In addition to the at least partially curved light polarizing elements, the container may be endowed with any combination of solid light polarizing elements chosen among dome-shaped polarizers, planar polarizers and polarizing portions of the container realized in any type of solid specular reflector of a dielectric non-liquid material that produces horizontally polarized light.

Especially, it may be provided, that the container contains a combination of at least two solid light polarizing elements, wherein the second light polarizing element is chosen among dome-shaped polarizers, planar polarizers and polarizing portions of said container realized in any type of solid specular reflector of a dielectric non-liquid material that produces horizontally polarized light

According to another embodiment of the invention, the device might comprise an additional light polarizing element, wherein the surface of the additional light polarizing element may be planar. In the case of an additional planar light polarizing element its surface may be oriented parallel, horizontal or at any angle to the direction of the local gravitational vector. For example, an additional first, light polarizing element, can be connected to the inner lateral surface of the container and an additional second polarizing element is connected to the outer lateral surface of the container. Hereby, the additional first light polarizing element and the additional second light polarizing element may be portions of a single solid light polarizing material. For example, this single solid light polarizing material may be a plastic polarizing element applied onto the upper rim of the container.

According to another embodiment the at least one at least partially curved polarizing element or an additional light polarizing elements of the device is formed from a sheet polarizer or formed of a specular reflector of dielectric non-liquid material with a uniform surface that produces horizontally polarized light. Especially the respective light polarizing element reflects horizontally polarized light with a minimum degree of polarization of 20%.

The surface of the at least one light polarizing element or the surface of one of the additional light polarizing elements is a non-Lambertian surface, whereas the outer lateral surface of the container is a Lambertian surface of low reflectivity. The outer lateral surface of the container is preferably colourless such as grey or black.

The form of the container can be designed differently, e.g., the container can have a trapezoid form, a cylinder form, a square form or any combination of said forms, said form being defined in a plane that is perpendicular or set at any angle to said bottom surface of the container.

According to a preferred embodiment, the container can possess means which maintains and/or stabilizes the level of the liquid within the container, such means being designed e.g. as a hole in the side wall or a drain pipe.

In a preferred device the at least partially curved light polarizing element is pierced with at least one opening that is large enough to allow mosquitoes and other biting insects to pass through to the zone of the device under the curved light polarizing element. Especially the mosquito trapping zone is located below the curved light polarizing element and above the liquid within the container.

The opening pierced through the surface of the at least partially curved light polarizing element may accommodate a cylinder-form funnel that protrudes above the surface of said light polarizing element and penetrates into the zone between the underside of the light polarizing element and the liquid in the container. The purpose of said cylinder-form funnel is to trap mosquitoes that enter said zone from flying out when said zone is closed off by an extension of the side wall of the container that reaches to the underside of the light polarizing element. Such a device can be used to count the insects that enter the device and thereby are caught and/or killed. Based on the number of mosquitoes caught and/or eggs laid, the device permits public health authorities to make appropriate decisions with regard to vector control measures to curtail outbreaks of disease.

In another embodiment of the device, the at least one solid light polarizing element is partially located inside the container and partially protruding over the liquid within the container. For example, the container can comprise a central dome that acts as a light polarizing element due to its smooth surface, high light absorbance and dielectric material.

The shape of the dome and its position relative to the upper rim of the container ensures that the dome surface reflects horizontally polarized light at the Brewster angle towards approaching mosquitoes regardless of their distance and flight altitude. Approaching mosquitoes in that manner are bound to perceive strongly horizontally-polarized reflected light from the dome that forms a strong contrast with the background.

Another embodiment of the device suitable for egg-laying by mosquitoes has a side wall that is inclined relative to the direction of the local gravitational vector. Said form of the device, which device is furthermore equipped with a central dome acting as a light polarizing element as explained above, is especially suitable for attracting mosquito species laying eggs directly on water surfaces or liquid surfaces, such as Anopheles mosquitoes, or for mosquito species laying eggs on surfaces slightly tilted from horizontal surrounding water or liquid bodies irrespective of the mosquito's taxonomic status. For example, to monitor egg-laying by Aedes mosquitoes, the inclined lateral surfaces may bear a water-absorbing or liquid-absorbing substrate such as one or more pieces of cellulose hardboard partially immersed in the liquid of the device onto which mosquitoes lay their eggs. To accommodate egg-laying mosquitoes, the device can comprise pieces of floating timber or other substrate floating on the surface of the liquid of the device. Further, when the device is deployed with an insecticide in the liquid of the device, mosquito eggs can be killed.

The container may comprise a polarizing portion forming the least partially curved at least one solid light polarizing and/or the container may comprise a polarizing portion as an additional light polarizing element. Such a polarizing portion may be realized during the manufacturing process of the container so as to reduce the fabrication costs of the functionalized device. Said polarizing portion may be for example a polarizing coating. The container may comprise a polarizing element integrated into or deposited on the inner lateral surface and/or on the outer lateral surface and/or over the upper rim of the container to the open side of the container.

According to an embodiment of the invention, the light polarizing element can especially be made of dark-coloured solid dielectric material with a smooth specular-reflection finish. The at least partially curved light polarizing element can be formed as a dome, which is set or adapted above the upper rim of the container to the open side of the container. Said saucer dome-shaped surface reflects light with a maximum degree of polarization chiefly in the horizontal plane when reflected at the Brewster angle at multiple point across its convex surface, as determined by the index of refraction of the material. The advantage of such an arrangement of elements of the device is that polarized light with a high degree of polarisation is visible to gravid mosquitoes flying at different distances and angles of elevation in the surroundings of the device equipped with a saucer dome-shaped polarizer at its top. This preferred device can be used to control populations of mosquitoes and other biting flies when treated with a substance that has insecticidal activity or when treated with a chemosterilant.

Preferably, the device may comprise elements which provide light intensity contrast while the at least one light polarizing element provides horizontally polarized light. For example, the surface of the light polarizing element may be black and the outer lateral surface of the container may be grey. Said embodiment is especially suitable for attracting egg-laying mosquitoes irrespective of their taxonomic status.

In a preferred variant, the device comprises additional elements which reflect light with different degrees of polarization, while at least one light polarizing element provides horizontally polarized light. For example, surfaces reflecting light with different degrees of polarization are provided on the device. This is achieved when horizontally polarized light is reflected with a maximum degree of polarization at the Brewster angle at multiple points on the smooth specular surface of the dielectric material forming the light polarizing element whereas light with a low degree of polarized light is reflected from outer lateral surface with low reflectivity of the container.

The liquid in the container can furthermore comprise a chemical substance in solution such as an insecticide selected from the group of contact insecticides, insect chemosterilants and/or chemical attractants for mosquitoes or biting insects.

The chemical substance is any biodegradable insecticide such as a contact insecticide like deltamethrin with the ability to poison insects when contacting with their cuticle after landing on the container or its contents. Alternatively, the chemical substance may be an insect chemosterilant or an insect growth regulator.

The chemical substance or mixture of substances can be released into the moisture, the liquid, onto the liquid or onto any element or surface of the device in the form of a solution or spray or from a substrate that serves as a slow-release method for insecticides and/or insect chemosterilants and/or insect growth regulators.

Insect pathogens such as entomophagous fungi, parasites, GM symbionts or DNA vectors targeting next generation mosquitoes or biting insects can be added to the device or to any of its surfaces or elements.

Any surface or element of the container can be covered, at least partially, with non-drying sticky material that retains mosquitoes or biting insects landing on it.

According to another preferred embodiment, the device may additionally comprise an artificial light source, which artificial light source directs light onto the at least one solid light polarizing element.

This artificial light source allows for the generation of horizontally polarized light by the at least one solid light polarizing element especially in a situation where no or not enough natural light is provided. For example, the artificial light source allows the generation and provision of horizontally polarized light by the at least one solid light polarizing element at night, or when the device is placed in a shadowed environment, where not enough natural light reaches the at least one solid light polarizing element. Thereby the device is more apparent for insects that are attracted to horizontally polarized light, even under difficult light conditions and/or placement situations.

In some embodiments, the device comprises a power unit providing electricity for the artificial light source. The power unit might be a battery or a photovoltaic unit or any other suitable power source, especially any combination of said power sources. It is also possible to power the artificial light source by a chemical reaction.

Furthermore, the activation and/or inactivation of the artificial light source might be controlled and/or regulated.

The device might be provided with an ambient light sensor, which ambient light sensor is coupled to a controller. When ambient light sensor detects the amount of ambient light and provides this data to the controller. If the ambient light is below a defined threshold, the controller generates a signal and the artificial light source is switched on.

It can be provided that the artificial light source is automatically switched off after a predefined time interval. If after this time interval the ambient light sensor detects that the amount of ambient light is still below the defined threshold, the artificial light source is switched on again.

Furthermore, switching on of the artificial light source can be coupled to an inactivation of the ambient light sensor and switching off of the artificial light source can be coupled to an activation of the ambient light sensor.

Furthermore, the controller can a clock and information regarding the times of sunset and sunrise. In this case it can be provided that the artificial light source is not inactivated between the time from dusk till dawn. Additionally, it can be provided that the ambient light sensor is not activated between the time from dusk till dawn.

According to another preferred embodiment, the device may optionally or additionally comprise an artificial light source, which artificial light source provides horizontally polarized light. In this case, it is not required that the horizontally polarized light provided by the artificial light source is directed onto the at least one solid light polarizing element. According to a preferred embodiment, the horizontally polarized light provided by the artificial light source is not directed onto the at least one solid light polarizing element at all.

With this artificial light source horizontally polarized light can be provided when no or not enough natural light is provided. For example, the artificial light source provides horizontally polarized light independently of the at least one solid light polarizing element at night, or when the device is placed in a shadowed environment, where not enough natural light reaches the at least one solid light polarizing element. Thereby the device is more apparent for insects that are attracted to horizontally polarized light, even under difficult light conditions and/or placement situation.

In some embodiments, the device comprises a power unit providing electricity for the artificial light source, which artificial light source is providing horizontally polarized light. The power unit might be a battery or a photovoltaic unit or any other suitable power source, especially any combination of said power sources. It is also possible to power the artificial light source powered from a chemical reaction.

Furthermore, the activation and/or inactivation of the artificial light source might be controlled and/or regulated.

The device might be provided with an ambient light sensor which is coupled to a controller. The ambient light sensor detects the amount of ambient light and provides this data to the controller. When the ambient light is below a defined threshold, the controller generates a signal and the artificial light source providing horizontally polarized light is switched on.

It can be provided that the artificial light source providing horizontally polarized light is automatically switched off after a predefined time interval. If after this time interval the ambient light sensor detects that the amount of ambient light is still below the defined threshold, the artificial light source is switched on again.

Furthermore, switching on of the artificial light source providing horizontally polarized light can be coupled to an inactivation of the ambient light sensor and switching off of the artificial light source can be coupled to an activation of the ambient light sensor.

Furthermore, the controller can comprise a clock and information regarding the times of sunset and sunrise. In this case it can be provided that the artificial light source providing horizontally polarized light is not inactivated between the time from dusk till dawn.

Additionally, it can be provided that the ambient light sensor is not activated between the time from dusk till dawn.

Especially, it may be provided, that the device does not rely on an ambient light sensor but only on time data saved in a programme of the controller. In that case, the artificial light source providing horizontally polarized light is automatically switched on at a first defined time, especially around dusk. Furthermore, the artificial light source is automatically switched off at a second defined time, especially around dawn.

The invention is furthermore achieved by a method to attract mosquitoes or biting insects in a specific physiological state to above, around, onto and/or inside a device as described above. Accordingly, a method is provided for catching and killing egg-laying mosquitoes and/or other biting insects.

The method comprises the following steps:
providing a solid light polarizing element producing horizontally polarized light, which at least one light polarizing element is at least partially curved, especially convex
b) providing a container, especially a container as described above;
c) arranging or incorporating said light polarizing element to said container to produce the maximum degree of polarization of reflected light;
d) positioning the device comprising the container and the at least one light polarizing element in a place, within which place insects and/or insect eggs have to be collected and/or within which place said insects and/or insect eggs are killed;
e) providing a moisture emitter within the container.

Furthermore, the invention is also achieved by the use of the device as described above, so as to attract mosquitoes and other biting insects in a specific physiological state to above, around, onto and/or inside the container of the device. Especially, to catch and/or kill egg-laying mosquitoes and/or other biting insects.

The method also provides the possibility that the insects and/or insects' eggs trapped and/or killed within the device are collected and counted.

This novel invention provides multiple advantages over existing methods as it exploits the innate response of egg-laying mosquitoes that respond to a combination of horizontally polarized light and moisture, especially water vapour, in search for an egg laying site. The device of the invention permits targeted deployment of insecticides and other mosquito-killing agents on surfaces of its elements and/or in liquid within the device. Such targeted deployment of mosquito-killing agents such as an insecticide has many advantages including environmental protection through avoidance of area-wide application of insecticides. Area-wide application of an insecticide frequently leads to resistance to the product due to mosquito populations being exposed to sub-lethal doses of the insecticide. In addition, the device of the invention serves as a highly reliable monitoring tool for estimating population levels of mosquitoes and other biting insects to permit public health authorities take appropriate action against these vectors of disease.

The herein disclosed embodiments, examples and variations of the preceding paragraphs, especially the general description and the description relating to the figures, including their various views or respective individual features, may be used independently or in any combination. Features described in connection with one embodiment are applicable to all embodiments unless the features are incompatible.

It should be expressly mentioned at this point that all aspects and embodiments which have been explained in connection with the device according to the invention equally concern or can be partial aspects of the method or the use of the device according to the invention. Therefore, if at any point in the description, definitions relating to the device according to the invention reference is made to certain aspects and/or interrelationships and/or effects, this applies equally to the method or the use of the device according to the invention. The same applies in reverse, so that all aspects and embodiments which have been explained in connection with the method according to the invention also equally concern or can be partial aspects of the device according to the invention.

### BRIEF DESCRIPTION OF THE DRAWINGS

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged to facilitate an understanding of the invention.

FIG. 1 shows a first embodiment of a device according to the invention.

FIGS. 2 and 3 show a second embodiment of a device according to the invention.

FIGS. 4 and 5 show a third embodiment of a device according to the invention.

FIGS. 6 and 7 show a fourth embodiment of a device according to the invention.

FIG. 8 shows a fifth embodiment of a device according to the invention.

FIGS. 9 and 10 show a sixth embodiment of a device according to the invention.

FIG. 11 shows the 1960 CIE colour diagram of a preferred low reflectance black material.

FIGS. 12 and 13 show an experimental setup.

FIG. 14 shows another experimental setup.

FIG. 15 shows the proportions of captured mosquitos in an experimental setup.

FIG. 16 shows a seventh embodiment of a device according to the invention.

FIG. 17 shows an eight embodiment of a device according to the invention.

### DETAILED DESCRIPTION

The same or equivalent elements of the invention are designated by identical reference characters. Furthermore, and for the sake of clarity, only the reference characters relevant for describing the respective figure are provided. It should be understood, that the embodiments described are only examples describing an embodiment of the device and/or method according to the invention. They are not intended to limit the scope of the disclosure.

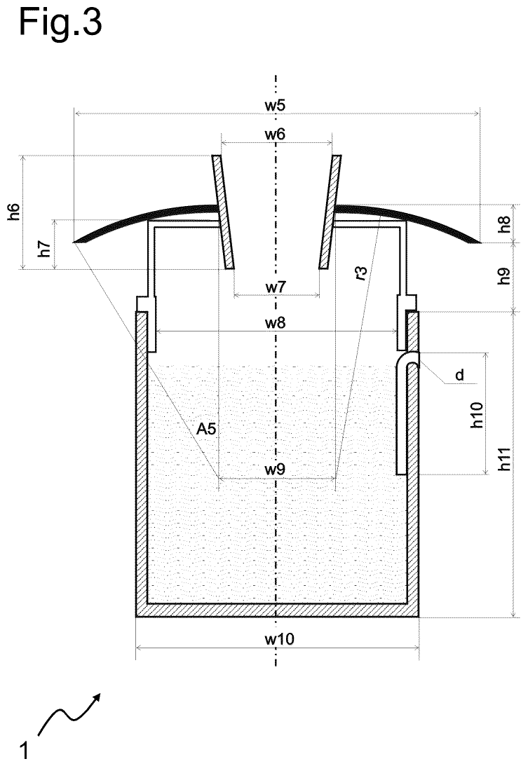

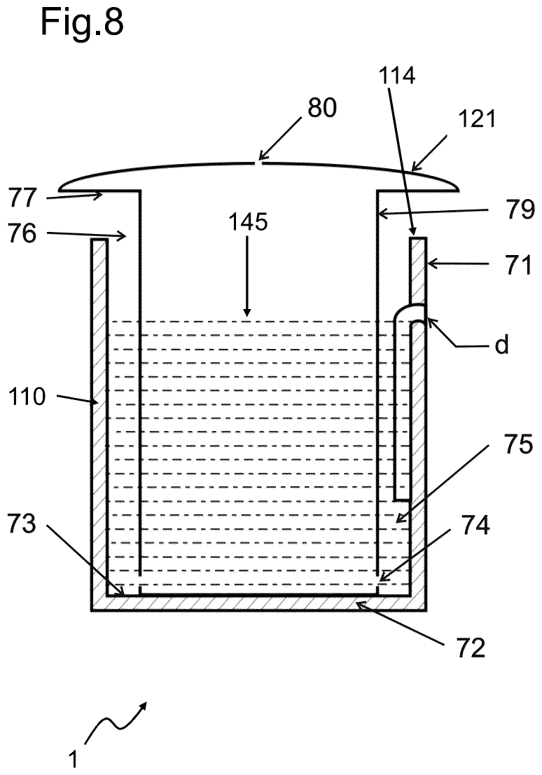

The invention is achieved by a device 1 comprising a container 110 and at least one solid light polarizing element 121, wherein at least one solid light polarizing element is set above the upper rim 114 of the container 110 and/or wherein at least one solid light polarizing element 121 is held or anchored or sits freely within the container 110 as shown in FIG. 4 to 8, and/or wherein one of the at least one solid light polarizing elements is located on or near said container 110 as shown in FIGS. 9 and 10.

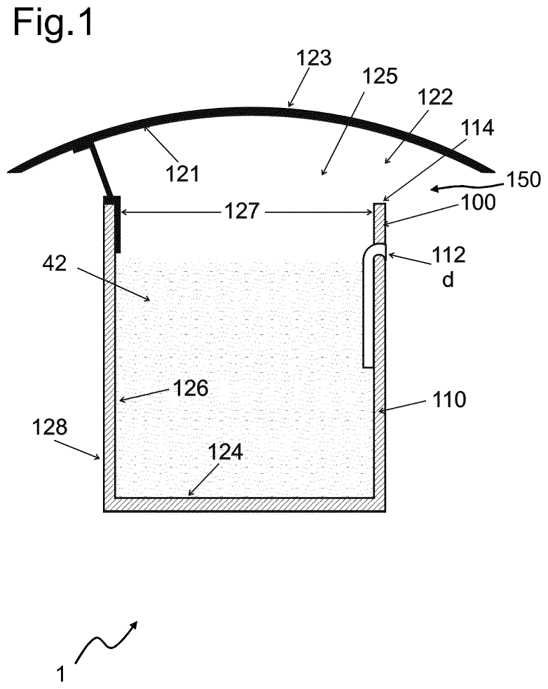

FIG. 1 shows a first embodiment of a device 1 to kill and/or capture mosquitoes and other biting insects according to the invention. The device comprises a container 110 which is equipped with at least one solid light polarization element 121 located outside said container 110.

The container 110 comprises a bottom having a bottom surface 124, and a side wall 100 having an inner lateral surface 126 and an outer lateral surface 128.

The container 110 comprises an upper rim 114 defining an aperture, which is especially defined as the upper rim of the container to the open and upper side of the container. Herein the area of the upper opening is defined as the area surrounded by the upper rim 114.

The container 110 is designed to release and/or emit moisture. In order to release moisture, the container 110 can be at least partially filled with a liquid, which liquid is selected from water or a water solution or any other suitable liquid. The liquid in the container 110 my comprise a mixture of water and hay (dried grass) to attract egg-laying mosquitoes. The surface of the liquid, especially water, in the container 110 is exposed to the air in order to produce high local relative humidity through evaporation of the liquid.

Alternatively, a sponge structure or an absorbent structure or the like can be arranged within the container 110, via which structure the moisture is slowly released from a reservoir.

The at least one solid light polarizing element 121 is at least partially curved, especially convex and produces horizontally polarized light.

The curvature of the light polarizing element 121 may be in one dimension such as in the case of a portion of a cylinder (see FIGS. 9 and 10) or may be in two dimensions such as in the case of a portion of a sphere.

The light polarizing element 121 can be formed out of a sheet polarizer or another type of solid specular reflector made, for example, of a dielectric non-liquid material.

Especially FIG. 1 shows a cross section of a device 1 with a light polarization element 121 in the form of a saucer-dome that protrudes over the upper rim of the container 110 and prevents rainwater from entering into the device 1. Especially the light polarizing element 121 may constitute a segment of a sphere.

An opening 150 between the underside of the light polarization element 121 and the upper rim 114 of the container 110 allows mosquitoes and other biting insects to enter into the container 110.

In an embodiment the curved surface 123 of the light polarizing element 121 is uniform.

In an embodiment the curved surface 123 of the light polarizing element 121 is dark coloured.

In an embodiment the curved surface 123 of the light polarizing element 121 is black.

In an embodiment according to FIG. 1 to 3, the at least one light polarizing element 121 is located above the upper rim 114 of the container 110. When the container 110 is used to attract and/or catch and kill mosquitoes and/or other biting insects the polarizing element 121 preferentially completely covers the opening surrounded by the upper rim 114 of the container 110, whereby a liquid such as water fills the inside of the container 110 at least partially.

According to the embodiments shown in FIG. 1 to 3 the curved light polarizing element 121 is arranged topping the container 110, wherein there is no connection of the curved light polarizing element 121 to the inside of the container 110 and especially wherein there is no connection of the curved light polarizing element 121 to the liquid within the container 110.

In a preferred embodiment the container 110 is topped by a solid convex light polarizing element 121 having the form of a saucer dome that constitutes a segment of a sphere. An example is provided in FIG. 1. The plane forming the preferably circular base of the convex light polarizing element 121 is positioned parallel to the bottom surface 124 of the container 110. It is understood that the saucer dome 121 is made of solid dielectric material with a specular-reflection finish on its convex surface 123. Alternatively, the saucer dome can be made of any solid material that is endowed with a smooth dielectric specular-reflection finish on its convex surface 123. Said saucer-shaped dome with a smooth specular-reflection finish reflects predominantly horizontally polarized light from at least parts of the dome-shaped surface 123 with a minimum degree of polarization of 5%, or of 10%, or of 15%, preferably with a minimum degree of polarization of 20%. Said saucer-shaped dome does not reflect vertically polarized light. Compared to its height, the long radius of curvature of said convex light polarizing element 121 is such that polarized light is reflected towards approaching biting insects at the Brewster angle regardless of the insect's altitude and direction of approach. Such polarized light with a maximum degree of polarization in the horizontal plane is visible to female mosquitoes flying at different distances and angles of elevation in the surroundings of the device. In said preferred embodiment the polarizing element 121 in the form of a saucer dome protrudes over the upper rim 114 of the container 110 and prevents rain water from entering the container. Particularly, the part of the least one light polarizing element, which part is protruding over the upper rim 114 of the container 110, covers an area which is bigger than an area covered by an upper opening 127 of the container (FIG. 1). The opening 122 between the underside of the saucer dome polarizing element 121 and the upper rim 114 of the container allows mosquitoes and/or other biting insect to enter the interior of the container into the zone 125 of the device between the underside of the saucer dome 121 and the liquid 42 in container 110 (FIG. 1).

The perimeter forming the base of said saucer dome light polarizing element 121 can have any form other than circular. For example, the perimeter of the plane forming said base of said saucer dome light polarizing element 121 can be a polygon. The radius of curvature of said saucer dome need not be constant in length. Said saucer dome need not be symmetrical in shape. Further, said saucer dome can be constituted using separate parts or units.

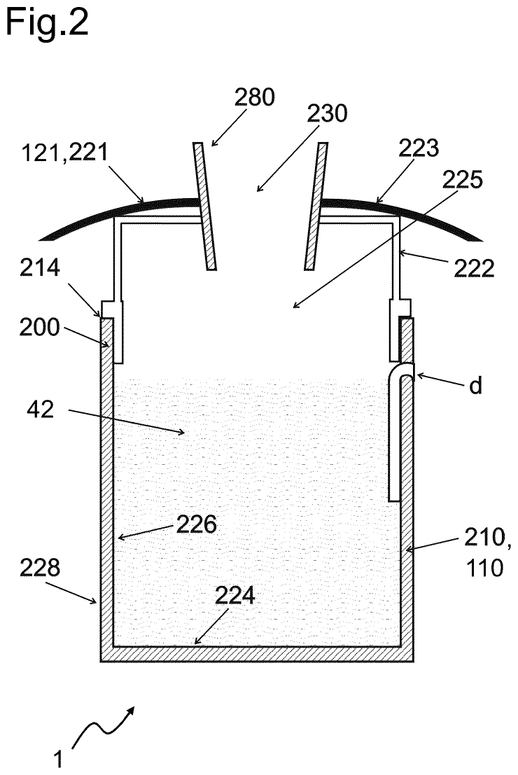

In a version of the preferred embodiment of a device 1 according to FIGS. 2 and 3 the surface 223 of one of the at least one light polarizing elements 121 having the form of a saucer dome 221 is pierced with at least one opening 230 that is large enough to allow mosquitoes and/or other biting insects to pass through the said polarizer element to reach its underside in the zone 225 over the liquid 42 in the container 210. In said embodiment, the space between the underside of the saucer-dome and the upper rim 214 of the side wall 200 of the container 210 can be closed off with a side wall extension 222. The material used to from said extension 222 of the side wall 200 of the container 210 above the upper rim 214 can possess the appropriate translucence to induce mosquitoes and/or other biting insects to pass through said saucer dome-shaped polarizer 221 into the zone 225 of the device between the underside of the saucer dome and the liquid 42 in container 210. Said material of appropriate transparency can, for example, be translucent plastic. Said extension 222 of said side wall 200 of the device above said upper rim 214 can be oriented parallel or at any angle to the direction of the local gravitational vector that allows it to reach the underside of the saucer dome. Alternatively, said extension 222 of the side wall 200 of the container 210 above the upper rim 214 can be straight or rise above the upper rim 214 in steps to meet the underside of the saucer-shaped dome at its top.

In an embodiment said opening 230 pierced through the surface of one of the at least one light polarizing elements 121 having the form of a saucer dome 221 accommodates a cylinder-form funnel 280, as in the example depicted on FIG. 2. Said cylinder-form funnel protrudes above the upper surface 223 of said saucer dome 221 and penetrates beneath the saucer dome 221 into the zone 225 between the underside of the said saucer dome 221 and the liquid 42 in container 210. The purpose of said cylinder-form funnel 280 is to provide a non-return entrance in order to prevent particularly mosquitoes and/or other biting insects that enter said zone 225 via the cylinder-form funnel 280 from flying out of said zone 225 that is closed off by extension 222 of side wall 200 between said upper rim 214 of the container 210 and the underside of said saucer dome 221. For purposes of clarity, said cylinder-form funnel 280 is one where the surface area circumscribed by the perimeter at the lower end of the cylinder-form funnel 280 is smaller than the area circumscribed by the perimeter at the top end of the cylinder-form funnel 280. The lower end of said cylinder-form funnel 280 is the end that opens into the zone 225 between the underside of the said saucer dome 221 and the liquid 42 in container 210.

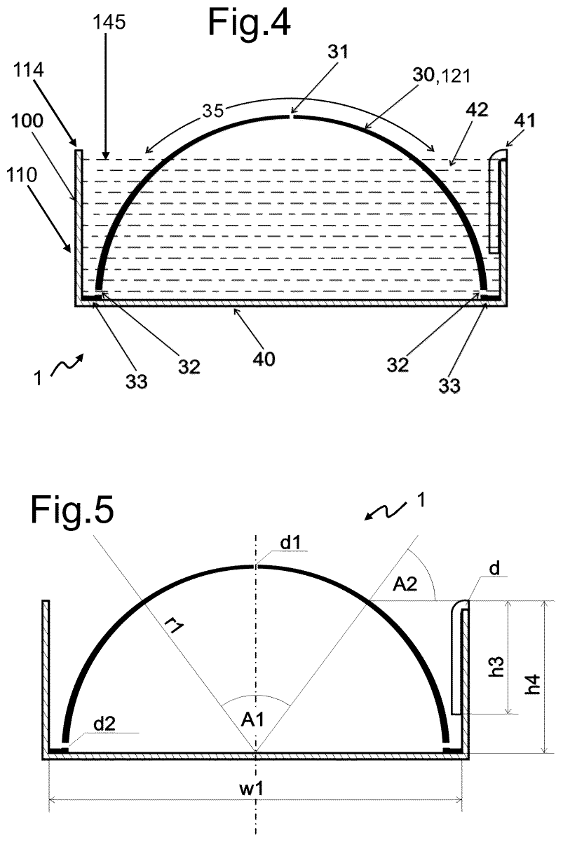

FIGS. 4 and 5 show a third embodiment of a device according to the invention and FIGS. 6 and 7 show a fourth embodiment of a device 1 according to the invention.

Especially FIG. 4 shows a cross section of the third embodiment, intended for killing mosquitoes and other biting insects, collecting mosquitoes and/or other biting insects, and collecting eggs of mosquitoes and/or eggs of other biting insects irrespective of their taxonomical status and FIG. 5 shows the suggested dimensions of elements of the embodiment shown in FIG. 4.

FIG. 6 shows a cross section of the fourth embodiment used for killing mosquitoes and collecting eggs of mosquitoes ovipositing directly on liquid surfaces or surfaces slightly tilted from horizontal surrounding liquid or water bodies and FIG. 7 shows the suggested dimensions of elements of the embodiment shown in FIG. 6, used for killing mosquitoes and other biting insects, collecting mosquitoes and/or other biting insects, and collecting eggs of mosquitoes and/or eggs of other biting insects ovipositing directly on liquid surfaces or slightly tilted surfaces surrounding liquid or water bodies.

In these embodiments the at least one light polarizing element 121 is partially located under the upper rim 114 in the container 110 and at least partially protruding above the level 145 of the liquid 42 present in the container 110.

The device 1 comprises a central dome 30 within the container 110, which dome 30 that acts as a light polarizing element 121 due to its smooth surface, high light absorbance and dielectric material (FIGS. 4, 6). The dome 30 is positioned in such a way that the plane defined by the upper rim 114 of the container 110 intersects the dome surface at 54°±20° (A2 in FIG. 5). The shape of the said dome 30 and its said position relative to the upper rim 114 of container 110 ensures that the dome surface reflects light at the Brewster angle towards approaching mosquitoes and/or other biting insects regardless of their distance and flight altitude. Approaching mosquitoes and/or other biting insects are in that manner bound to perceive strongly horizontally-polarized reflected light from the dome 30 that forms a strong contrast with the background.

FIGS. 4 and 6 illustrate an embodiment of a device 1 comprising a polarizing element 121 designed as a central dome 30 located within the container 110.

When in use, the device 1 is at least partially filed with a liquid 42. The dome 30 is arranged so that it comprises a part 35 that is above the liquid level 145 when the device 1 is in use. In an embodiment said central dome 30 has a flat ring-shaped base 33 that doubles as a holder during fabrication of the dome 30 and acts as a spacer between the dome 30 and the inner lateral surface 126 of the container 110. Said central dome 30 has holes 32 above its base 33 allowing liquid levels to equalize between the inside and outside of the dome 30.

In an embodiment of a device 1 not shown here, it comprises at least one polarizing element 121 designed as a central dome 30 arranged within a container 110 so that it comprises a part 35 that is above the liquid level 145 when the device 1 is in use and where the surface of said central dome 30 is pierced with at least one opening that is large enough to allow mosquitoes and/or other biting insects to pass through a cylinder-form funnel 280 (see FIG. 2) forming a non-return entrance to the zone of the device 1 that is between the underside of said dome 30 and over the liquid 42 in the container 110.

In an embodiment one third, preferably two thirds, of the surface of the at least one light polarizing element 121 is under the liquid 42 present in the container 110 as illustrated in FIGS. 4 and 6.

In another embodiment, the at least one light polarizing element 121 sits freely on its flat ring-shaped base 33 on the bottom surface 124 of the container 110 or is attached or held or anchored with its flat ring-shaped base 33 to the bottom surface 124 of the container 110. FIGS. 4 to 7 illustrate such an embodiment.

The perimeter forming the base of said light polarizing element 121 in the form of a central dome 30 can have any form other than circular. For example, the perimeter of the plane forming said base of said central dome 30 can be a polygon. The radius of curvature of said central dome 30 need not be constant in length. Said central dome 30 need not be symmetrical in shape. Further, said central dome 30 can be constituted of separate parts or units.

In an embodiment the surface of one of the at least one light polarizing element 121 is pierced with holes over its surface to vent air.

In an embodiment the surface of the at least one light polarizing element 121 is pierced with at least one hole 31 within the part 35 of the surface of the at least one light polarizing element 30, which part 35 is located over the liquid 42 to vent air (FIGS. 4 and 6). For example, the surface of the at least one light polarizing element 30 is pierced with hole 31 at its apex.

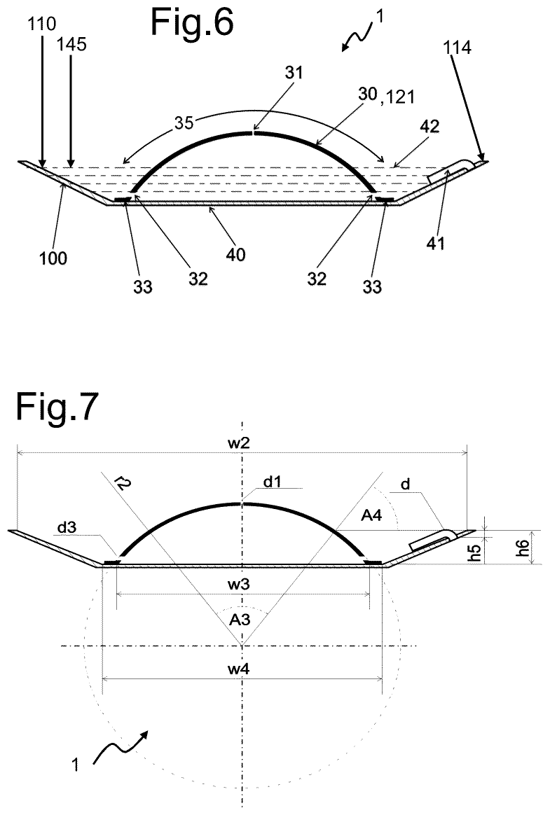

FIG. 8 shows a fifth embodiment of a device 1 according to the invention, especially FIG. 8 shows a cross section of an embodiment with a light polarizing element 121 that protrudes over the upper rim 114 of the container 110 and prevents rainwater from entering into the device. Hereby, the at least one light polarizing element 121 is only partially located within the container 110 and sits freely, or is attached or is held or anchored to the inside of the container 110, for example to its bottom surface, for the purpose of attracting mosquitoes and/or other biting insects. The light polarizing element 121 is formed as a saucer dome top, which polarizing element 121 protrudes over the upper rim 114 of the container 110. Especially the part protruding over the upper rim 114 of the container 110 reaches outside the area circumscribed by the upper rim 114 to cover an area which is bigger than the area of the upper opening 76 of the container 110, thereby forming a roof 77, which roof 77 prevents rainwater from entering into the container 110. The container 110 comprises sidewall 71 and a bottom 72 with an upper bottom surface 73. Especially the at least one polarizing element 121 is at least partially located and held or anchored or sits inside the container 110 and especially within the liquid 75. Preferentially the at least one polarizing element 121 is attached to the upper bottom surface 73 of the container 121.

The at least one polarizing element 121 that is only partially located within the container 110 as shown in the embodiment according to FIG. 8 may comprise holes 74 above its base, which base is attached to the upper bottom surface 73 of the container 110, allowing liquid levels 145 to equalize between the inside and the outside of the polarizing element 121. Also, this embodiment may comprise a drain pipe d for maintaining the level of the liquid 75 within the container 110.

In an embodiment of the device 1 (not shown here), where the at least one light polarizing element 121 is only partially located within the container 110 and sits freely, or is attached or is held or anchored to the inside of the container 110, for example to its bottom surface as depicted in FIG. 8, the surface of said polarizing element 121 with, for example, a saucer dome top is pierced with at least one opening that is large enough to allow mosquitoes and/or other biting insects to pass through a cylinder-form funnel 280 as shown in FIG. 2 forming a non-return entrance to the zone of the device that is between the underside of said saucer dome top and over the liquid 75 in the polarizing element 121.

The perimeter forming the base of said light polarizing element 121 with a saucer dome top can have any form. For example, the perimeter of the plane forming said base of said polarizing element 121 can be circular or a polygon. The radius of curvature of the saucer dome top of polarizing element 121 need not be constant in length. Said saucer dome 121 need not be symmetrical in shape. Further, said saucer dome polarizing element 121 can be constituted of separate parts or units.

In an embodiment the roof 77 or part of the sidewall 79 of the at least one light polarizing element 121, which part of the sidewall 79 is protruding over the upper rim 114 of the container 110, comprises at least one hole 80 or is pierced with a plurality of holes to vent air.

In an embodiment the container 110 has sharp edges on the top part or upper rim 114 of the container 110 (FIGS. 4 and 6).

In an embodiment, illustrated in FIGS. 6 and 7, the container 110 has an inclined side wall 100. This embodiment of the device 1 equipped with a central dome 30 that acts as a light polarizing element 121 is especially suitable for attracting egg-laying mosquito species and/or other biting insects that lay eggs on inclined surfaces above the liquid level 145, especially water level, irrespective of their taxonomical status.

In an embodiment of a device 1 comprising a container 110 equipped with a central dome 30 that acts as a light polarizing element 121 and having an inclined side wall 100, illustrated in FIGS. 6 and 7, said side wall 100 may bear a liquid or water-absorbing substrate, such as piece of cellulose hardboard, partially immersed in the water of the device and onto which the mosquitoes and/or other biting insects lay their eggs. This embodiment is particularly suitable for attracting egg-laying Aedes mosquito species.

In an embodiment of a device 1 comprising a container 110 equipped with a central dome 30 that acts as a light polarizing element 121 and having an inclined wall 100, illustrated in FIGS. 6 and 7, the water in the container 110 comprises pieces of floating timber or other floating substrate on which mosquitoes and/or other biting insects lay their eggs. This embodiment is especially suitable for attracting egg-laying Aedes mosquito species.

An embodiment of the device 1 comprising a container 110 equipped with a central dome 30 that acts as a light polarizing element 121 and having a side wall 100 closing at an angle greater than 45° with the direction of the local gravitational vector is illustrated in FIGS. 6 and 7. This embodiment is especially suitable for mosquito species laying eggs directly on water surfaces such as egg-laying anopheline mosquito species or for mosquito species and/or other biting insects laying eggs on surfaces slightly tilted from horizontal surrounding water bodies irrespective of the insect's taxonomic status.

All devices 1 described in FIG. 1 to 8 and also the devices furthermore described in FIGS. 9 and 10 can be equipped with additional light polarizing element 121 with a planar surface (not shown). In the case of a planar light polarizing element its surface may be oriented parallel, horizontal or at any angle to the direction of the local gravitational vector.

FIGS. 9 and 10 show a sixth embodiment of a device according to the invention. Especially FIG. 9 shows an axonometric view of an embodiment of a device 1 used for killing mosquitoes and for collecting eggs of mosquitoes irrespective of their taxonomical status in a container and FIG. 10 shows a cross section and suggested dimensions of this device 1.

Hereby, two light polarizing elements 121 are provided, wherein a first light polarizing element 20 is attached on the inner lateral surface 26 of the container 110 and a second light polarizing element 21 is arranged on the outer lateral surface 28 of the container 110. In an embodiment said light polarizing elements 20, 21 are portions of a single light polarizing element 121. For example, this may be a plastic light polarizing element applied on the upper rim 14 of the container 110.

In an embodiment the container 110 is not closed nor does it have steep vertical sidewall 100, but its side wall is opened up and presented with an accompanying light polarizing element 121 reflecting horizontally polarized light, for example, a light polarizing element 121 with a saucer-dome form, and installed in the vicinity of a naturally occurring water body for the purpose of attracting mosquitoes and/or other biting insects.

The term “opened up” especially refers to a container 110 with inclined side walls as in FIGS. 6 and 7. The side walls are specially inclined in such a way that the container 110 opens up or widens the upper rim of the container 110 to the open side of the container 110. Preferably the bottom surface of the container 110 is smaller than the area of the upper opening of the container 110. The phrase “its side wall is opened up and presented with an accompanying light polarizing element 121” especially describes an embodiment with an inclined side wall wherein the at least one light polarizing element 121 is optionally placed next to the container 110 or is associated with the bottom surface of the container 110, so that at least the plane that forms the base of the light polarizing element 121 is aligned horizontally, when the device 1 is placed for use.

It is understood that a plurality of light polarizing elements comprising or additionally to the at least one at least partially curved light polarizing element 121 can be arranged to the outer lateral surface 128 and/or set above of the upper rim 114 of the container 110 for the purpose of attracting mosquitoes and/or other biting insects.

Light polarizing elements are well known to the person skilled in the art and will not be further described here. Light polarizing elements may be made in plastic. It is understood that the container 110 may comprise in or on its body, preferably on or above said upper rim, polarizing materials. For example, the container 110 may be made in ceramic or in glass or in plastic and may comprise a polarizing portion. Such a polarizing portion may be realized during the manufacturing process of the container 110 so as to reduce the fabrication costs of the functionalized container. Indeed, incorporating a polarizing portion in the container avoids the need to adapt to the container a separate polarizing element such as a foil or a polarizing element set on or above the container. Said polarizing portion may for example be a polarizing coating or a polarizing finish to the material. The container 110 may comprise a polarizing element integrated into or deposited to the inside surface and/or the outside surface and/or set above the container 110 for the purpose of attracting mosquitoes and/or other biting insects.

In an embodiment the container 110 has any combination of solid light polarizing elements, wherein the additional light polarizing elements can be chosen among said dome-shaped polarizers, planar polarizers and polarizing portions of the container 110 realized in any type of solid specular reflector of a dielectric non-liquid material that produces horizontally polarized light.

All embodiments described with regards to FIG. 1 to 10 can furthermore incorporate light intensity contrast and differential polarized light reflectance.

In an embodiment the surface of at least one of the light polarizing element 121 and optionally of additional light polarizing elements is a non-Lambertian surface.

In an embodiment at least the outer lateral surface 128 of the container 110 is a Lambertian surface.

In an embodiment the outer lateral surface and/or the inner lateral surface of the container 110 has a reflectivity R lower than 60%, preferably lower than 5%. The reflectivity R is defined as the fraction of light being reflected and/or scattered by said surfaces and is defined for illuminating light having wavelengths between 350 nm and 700 nm. The reflection from said component has a flat spectral shape, defined in that said reflection R has a value between 0.9×R and 1.1×R defined over a wavelength range between 350 nm and 700 nm, wherein R is a reference reflectivity defined at 500 nm. The formula 0.95×R means that the reflectivity is 95% of the reflectivity R at 500 nm, and the formula 1.05×R means that the reflectivity is 105% of the reflectivity R at 500 nm. Said component is preferably colourless defined in the 1960 CIE colour diagram.

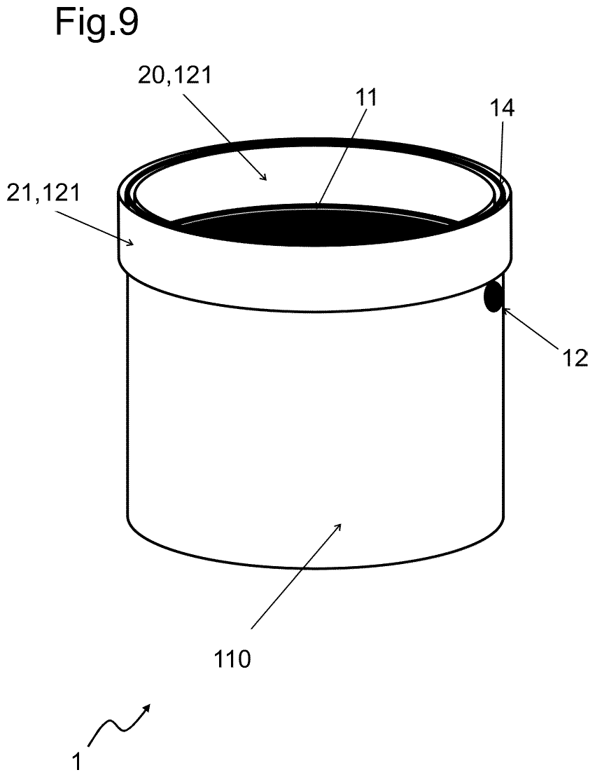

FIG. 11 shows the 1960 CIE colour diagram of a preferred low reflectance black material.

A colourless surface may be grey or black and has an x value defined between 0.210 and 0.420 and a y value defined between 0.22 and 0.43 in the 1960 CIE colour diagram taken from DataTool software, measured by DataColor spectrophotometer. In some embodiments, said inner and outer lateral surfaces of the container 110 has a flat reflection spectrum, as defined above, within the wavelength range between 360 nm and 700 nm.

In an embodiment the device 1 comprises elements which provide light intensity contrast which is implemented while the at least one light polarizing element 121 provides horizontally polarized light. In a preferred embodiment light intensity contrast is provided on the device 1 using a light polarizing element 121 which is black and using an outer lateral surface of the container 110 which is be grey. Said embodiment is especially suitable for attracting egg-laying mosquitoes irrespective of their taxonomical status.

In an embodiment the device 1 comprises additional elements which reflect light with different degrees of polarization which is implemented while the at least one light polarizing element 121 provides horizontally polarized light. In a preferred embodiment surfaces reflecting light of different degrees of polarization are provided from the device when horizontally polarized light is reflected with a maximum degree of polarization at the Brewster angle at multiple points on the specular surface of the dielectric material forming the light polarizer whereas light of a low degree of polarization is reflected from outer lateral surface 128 of the container 110 with said reflectivity R lower than 60%, preferably lower than 5%. Said embodiment is especially suitable for attracting egg-laying mosquitoes irrespective of their taxonomical status.

In embodiments the container 110 may have, defined in a plane perpendicular to said bottom surface 124, a trapezoid form, a cylinder form, a square form or any combination of said forms.

In an embodiment the container 110 is at least partially filled with liquid, which liquid is selected from pure water or a water solution for egg-laying mosquitoes irrespective of taxonomic status.

In an embodiment the surface of water in the container 110 is exposed to the air in order to produce high local relative humidity through water evaporation.

In an embodiment the container 110 has means which maintain and or stabilize the level 145 of the liquid 42 within the container 110.

In an embodiment said means which maintains the level of the liquid is a hole 112 in the outer casing or side wall 100 of the container 110, a drain pipe and/or additional liquid pipe that prevents loss of mosquitoes and/or other biting insects, or loss of mosquito eggs floating on the surface of the liquid. FIG. 1 illustrates a drain piper d comprising a drainer opening 112.

In the embodiments shown in FIGS. 1 to 8 said means of maintaining the level of the liquid in the container 110 is a drain pipe d.

In an embodiment the height h2 of the drain pipe d is between 30 and 120 mm.

In an embodiment the volume of the container 110 is between 0.5 litre and 20 litres.

In an embodiment the preferred height of the container side wall 100 is between 100 and 300 mm.

In an embodiment the preferred diameter or width of the container 110 is smaller than 600 mm. A preferable minimal diameter or width of the container 110 is 120 mm.

In an embodiment the container 110 comprises at least one sensor (not shown) which measures the liquid level 145 present in the container 110. In use, still water has been identified as the most efficient liquid as ripples on a liquid surface may reduce the catching efficiency of the device for mosquitoes.

The sensor may be connected to a controller, which controller activates a signal device when the liquid level 145 reaches or falls below a defined minimum. The signal device may produce an acoustic or a visual signal or the like, or the controller or the signal device may produce an electronic signal which can be detected remotely.

In an embodiment the liquid in the container 110 comprises light-absorbing elements in the form of submerged granules, flakes or fibres.

Preferred dimensions of the elements of the embodiment depicted in FIGS. 4 and 5 are as follows:

The angle A2 is the angle at which the plane defined by the upper rim of the container intersects the surface of the dome 30 (see FIG. 5). The diameter of the part of the dome surface protruding over the said plane is seen from the centre of the sphere defining the said dome surface under angle A1 (see FIG. 5).

In an embodiment where the container 110 has a vertical side wall 100, i.e. set parallel to the local gravitational vector, A1 and A2 are determined by the Brewster angle on the material of the dome. Considering the available materials, the preferred angles are A2=54°±20° and A1=72°+20°. The preferred linear dimensions of the embodiment are defined considering the greatest possible liquid volume of the container 110 and portability.

The inner diameter of the drain pipe d is preferably between 5 mm and 12 mm. The thickness of the wall of the tube d is preferably between 1-2 mm.

The central opening d1 of the dome 30 has a preferred diameter between 1 mm and 5 mm.

The spacer dimension d2 is preferably between 3 mm and 7 mm long.

The radius r1 of the dome 30 is between 120 mm and 180 mm.

The width w1 of the container 110 is between 140 mm and 300 mm.

The height h3 of the drain pipe d is between 60 mm and 80 mm.

The height h4 of the side wall 100 is between 100 mm and 140 mm.

In an embodiment wherein the container 110 has a side wall closing an angle greater than 45° with the direction of the local gravitational vector (see FIG. 6) the preferred dimensions of the elements of the embodiment are depicted in FIG. 7 as follows:

The size of the angles A3 and A4 are determined by the Brewster angle on the material of the dome as described for A1 and A2 in FIG. 5. Considering the available materials, the preferred angles are A4=54°±20° and A3=72°±20°.

d refers to a drain pipe with minimum 5 mm inner and maximum 14 mm outer diameter.

The inner diameter of the drain pipe d is preferably between 5 mm and 12 mm.

The thickness of the wall of the drain pipe d is preferably between 1-2 mm.

The central opening d1 of the dome 30 has a preferred diameter between 1 mm and 5 mm.

The spacer dimension d3 is preferably between 3 mm and 7 mm long.

The holes above the base d3 are preferably between 3 mm and 7 mm in diameter.

The radius r2 of the dome 30 is between 120 and 180 mm.

The width w4 of the base of the container 110 is between 150 and 300 mm.

The height h5 of the drain pipe d is between 10 and 20 mm.

The height h6 of the container side wall 100 is between 40 and 80 mm.

Preferred dimensions of elements of the embodiments of the device 1 depicted in FIG. 2 are presented in FIG. 3.

The size of angle A5 is determined by the Brewster angle on the material of the dome as described for angles A1 and A3 in, respectively, in FIGS. 5 and 7.

Considering the available materials, the preferred angle for A5=40°±5°.

The radius of the saucer dome r3 is between 100 mm and 150 mm.

### The Height H6 of the Cylinder Funnel Is Between 50 Mm and 160 Mm.

The lower opening of the cylinder funnel is positioned at a distance h7 of between 30 mm and 80 mm below the top rim of the translucent extension 222 of the side wall of the container 210 that serves to close the space between upper rim 214 of the container and the underside of said saucer dome 221.

The height h8 of the saucer dome 221 is between 18 mm and 44 mm.

The height h9 of the translucent extension 222 of the side wall of the container 110 that serves to close the space between upper rim 214 of the container 110, 210 and the underside of said saucer dome 221 is between 50 mm and 150 mm.

d refers to a drain pipe with 5 mm inner diameter and 14 mm outer diameter.

The height h10 of the drain pipe d is between 30 and 80 mm.

The thickness of the wall of the drain pipe d is preferably between 1-2 mm.

The height h11 of the container side wall 200 is between 100 and 400 mm.

The diameter w5 of the saucer dome 221 is between 215 and 352 mm.

The diameter or width w6 of the top end of the cylinder funnel 280 is between 100 and 140 mm.

The diameter or width w7 of the bottom end of the cylinder funnel 280 is between 80 and 120 mm.

The diameter w9 of the opening in the saucer dome polarizer 221 supporting the cylinder funnel 280 is between 80 and 120 mm.

The diameter w10 of the container 210 is between 150 and 330 mm.

The inner diameter W8 of the container 210, 110 at the base of the side wall extension 222 that serves to close the space between upper rim of the container 210, 110 and the underside of said saucer dome 221 is between 140 and 320 mm.

In any of the described embodiments said container 110 may provide, that an inner lateral surface and an outer lateral surface of the container 110 is treated or impregnated with a chemical substance. In an embodiment said inner lateral surface and/or said outer lateral surface may comprise portions treated with an UV absorber and/or portions treated with an insecticide. For example, in a variant only the outer lateral surface of the container 110 comprising said upper sharp edge may comprise an insecticide and/or an UV absorber and/or an UV absorber sheet.

In an embodiment the liquid, especially water, within the container 110 comprises insecticides selected from the group of insecticides capable of killing mosquitoes, and/or chemical attractant for mosquito vectors of disease.

In an embodiment the liquid in the container 110 comprises a mixture of water and hay (dried grass) to attract egg-laying mosquitoes.

In an embodiment the container 110 comprises a light polarizing element 121 or an additional polarizing element that is treated or impregnated with a chemical substance.

In an embodiment the surface of one of the at least one light polarizing element 121 or an additional polarizing element of the device 1 is treated or impregnated with a chemical substance.

In an embodiment said chemical substance is any biodegradable insecticide with the ability to poison insects when contacting with their cuticle after landing on any element or part of the device 1 or its liquid content. The preferred group of substances are synthetic pyrethroids, in which case the preferred substance is deltamethrin or a related pyrethroid insecticide.

In an embodiment said chemical substance is any insecticide operating upon contact with it and possessing the ability to poison insects.

It is generally understood that said chemical substance may be a mixture of chemical substances.

In an embodiment said chemical substance is any contact insecticide.

In an embodiment said chemical substance is an insect chemosterilant.

In an embodiment said chemical substance is an insect growth regulator.

In an embodiment said chemical substances can be released into the liquid, onto the liquid within the container 110 or onto any surface or onto any part of the device 1 from a substrate that serves as a slow-release method for insecticides and/or insect chemosterilants.

In an embodiment any part of the device 1 may be treated impregnated with an insecticide, an insecticide synergist, an insect growth regulator, an insect chemosterilant and/or a surfactant or by any combination of said substances.

In an embodiment insect pathogens such as entomopathogenic fungi, parasites, GM symbionts or DNA vectors targeting next generation mosquitoes or biting insects can be added to any part of the device 1.

In an embodiment the lateral surface of the container 110 is covered with non-drying sticky material that retains mosquitoes or other biting insects landing on its surface.

In an embodiment any part of the device 1 may be treated with non-drying sticky material that retains mosquitoes or other biting insects landing on its surface.

The invention is also achieved by the use of the device 1 as described above, so as to attract mosquitoes and other biting insects in a specific physiological state onto any surface of the device, above, around and/or to the inside of the container 110 of the device 1.

The invention is also achieved by a method for attracting mosquitoes and biting insects and for collecting mosquitoes and other biting insects, for collecting mosquito eggs and eggs of other biting insects irrespective of their taxonomic status, and for killing said insects using the device 1 of the invention comprising the steps of:
providing a solid light polarizing element 121 producing horizontally polarized light, which at least one light polarizing element 121 is at least partially curved, especially convex
providing a container 110, especially a container 110 as described above;
arranging or incorporating said light polarizing element 121 to said container 110 to produce the maximum degree of polarization of reflected light;
positioning the device 1 comprising the container 110 and the at least one light polarizing element 121 in a place, within which place insects and/or insect eggs have to be collected and/or within which place said insects and/or insect eggs are killed;
providing a moisture emitter within the container 110.

The method also provides the possibility that the insects and/or insects' eggs trapped and/or killed within the device are collected and counted.

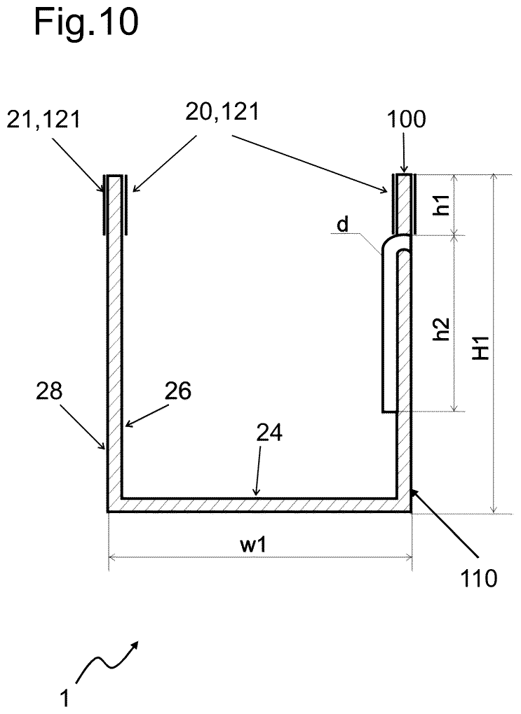

The following paragraphs describe the experimental work that has been the basis of the invented method and devices 1 of the invention with reference to FIG. 12 to 15.

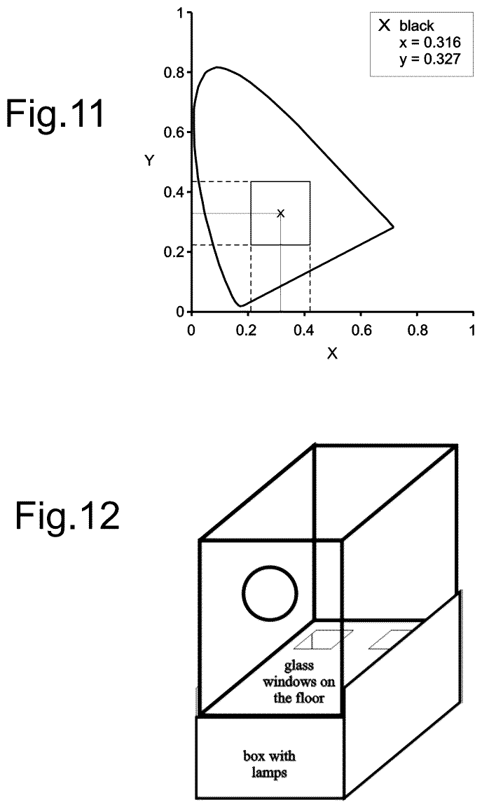

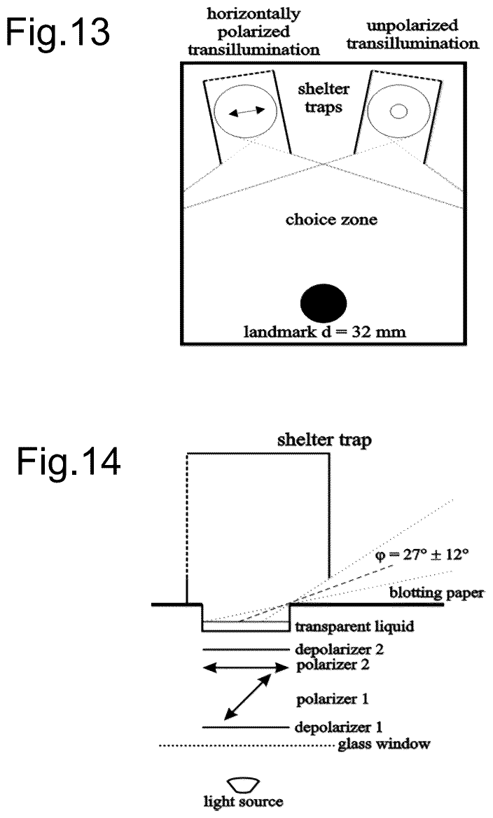

FIGS. 12 and 13 show an experimental setup. Especially FIG. 12 schematically shows an experimental cage adapted on a box comprising lamps and glass windows on its floor, arranged for testing responses of An. gambiae mosquitoes to linearly polarized light and FIG. 13 shows a view from above of the cage shown in FIG. 12 showing the arrangement of Petri dishes within their respective shelters, arranged for An. gambiae mosquito experiments. FIG. 14 show another experimental setup with transillumination of a liquid in a Petri dish with unpolarized light as shown, or by horizontally polarized light when depolarizer 2 was placed under depolarizer 1. The angle indicated on the right in the figure indicates the viewing range in which An. gambiae mosquitoes could see the liquid surface from the cage. FIG. 15 shows the amount of capture of mosquitos in an experimental setup, especially proportions of mosquitoes captured in shelters above Petri dishes transilluminated by horizontally polarized (dark boxes) and unpolarized light (clear boxes).

Mosquitoes were from a colony of An. gambiae (16CSS strain, derived from adults that were wild-caught in 1974 in Lagos, Nigeria) maintained in a walk-in climate chamber at 28 °C and 80% RH, under a 12:12 hour light: dark cycle with 1 h light ramps between the photophase and the scotophase. Larvae were raised in plastic trays (300 larvae in 400 ml demineralised water per tray) fed with powdered Tetramin™ nutrient for tropical fish until they pupated. Imagoes emerged within transparent Plexiglass@ rearing cages (35 cm W, 35 cm L, 55 cm H) provided with 10% sucrose solution to feed ad libitum. Water and a humid refuge were provided by wet cotton placed on fine metal netting in the centre of the roof of the cage. Sexes were not separated, and females were considered to have mated within 48 hours of emergence.

Experiments were performed simultaneously in a darkened walk-in climatized cabinet at 28 °C and 80% RH, under continuous darkness, in two identical experimental cages made of Plexiglas@, with dimensions as described above. At top of the cages, 10% sucrose solution was provided in cotton feeders. All inner surfaces of the cages were covered with white blotting paper. Each cage stood on a metal frame (35 cm W, 40 cm L, 25 cm H) housing dimmable illumination with openings on the side and bottom to prevent accumulation of heat and with 10×10 cm windows 80 mm apart on the metal frame top to support Petri dishes (FIG. 12). Visual range illumination was provided with a pair of 15W incandescent bulbs (Special T26/57 FR15, Osram GmbH, Munich, Germany) and UV illumination was provided by a pair of independently dimmable high frequency UV-emitting fluorescent tubes (Sylvania blacklight F8W/T5/BL368; Havells Sylvania Switzerland AG, Zürich, Switzerland) fixed under the windows of the metal frame. Petri dishes (76 mm diam.) containing transparent oviposition substrates (water and paraffin oil) were placed 110 mm apart on the two windows, one transilluminated by horizontally polarized and the other by unpolarized light in a given experiment (FIG. 13). An elevated cage floor formed sockets around the Petri dishes (FIG. 14). Each Petri dish was covered by a cardboard shelter (80 mm W, 135 mm L, 170 mm H; FIG. 13). Mosquitoes could see the liquid surface only at angles between 15°-39° to the horizontal (FIG. 14). Inside and outside surfaces of each shelter were covered with white blotting paper and the inner surfaces were treated with Tanglefoot Tangle-trap insect glue (The Tanglefoot Company, Michigan, USA) to trap mosquitoes. A black cardboard disk of 32 mm diam. was placed on the middle axis of the cage on the floor in front of the shelters in all 4 experiments as a landmark.

Intensity and polarization characteristics of visible transillumination was controlled by placing 2 layers of lens cleaning tissue (Wild Leitz AG, Zürich, Switzerland) acting as diffusers and two identical polarizer sheets (ITOS IP38, ITOS Gesellschaft für Technische Optik GmbH, Mainz, Germany) between the Petri dish and the glass window. To produce horizontally polarized transillumination both polarizers were placed above the diffusers and to produce unpolarized transillumination they were placed between the diffusers. The upper polarizer always had its axis of transmission parallel to the opening of the shelter. To equalize intensities of light radiating from the dishes providing an illuminance of about 0.38 lux at the bottom of the cage (all measured with a ST-8820 environment meter, ELV Elektronik AG, Leer, Germany) the lower polarizer was rotated with respect to the upper one (FIG. 14). Under UV illumination a single UV-transmitting sheet polarizer (OUV5050, Knight Optical Ltd., Harrietsham, UK) and two layers of diffuser were used as above over the dimmable high frequency UV lamps to produce horizontally polarized and unpolarized transillumination of equalized intensities. Positions of the polarized and unpolarized transilluminated Petri dishes were randomized within cages.

All Petri dishes contained 26 ml of either of two liquid oviposition substrates both able to trap mosquitoes alighting on them: (I) Demineralized tap water the surface tension of which was reduced with adding 6 drops ILFOTOL wetting agent (Harman Technology Ltd., Knutsford, UK) to 26 ml water and (II) paraffin oil (spectroscopy grade, Fluka Chemie GmbH, Buchs, Switzerland) representing a transparent odourless liquid that was viscous enough to retain mosquitoes and possesses optical characteristics very similar to that of water, but without generating a gradient of water vapour around the oviposition dish.

In all experiments groups of 10-20 six-to sixteen-day-old gravid or non-gravid females were released into the test cage for 24 hours. In some groups the number of individuals was lower than 20 due to mortality during egg-maturation. The duration of experiments and isolation from potential hosts within the experimental chamber ensured stochastic time-separation between activation of individual females. Experiments were performed in 4 different arrangements. In experiment 1, 16 groups of gravid mosquitoes were tested with visible light transilluminating clear water. In experiment 2, conditions were as in experiment 1, but were made with paraffin oil. In experiment 3, 16 groups of non-gravid mosquitoes were tested with visible light transilluminating clear water. In experiment 4, 9 groups of gravid mosquitoes were tested under conditions as in experiment 1, but with UV transillumination.

To test for a possible bias by mosquitoes for dishes on left or right positions within the cage, proportions of mosquitoes found in right and left shelters were compared using the Wilcoxon matched pair test (WMPT). To examine preferences for either Petri dish, the proportion of mosquitoes trapped in and above dishes in the four experimental arrangements was compared using the WMPT test. To estimate the overall interest by mosquitoes for the dishes in the 4 experimental arrangements, the number of mosquitoes trapped in each shelter as a proportion of the number of mosquitoes introduced into the cage was compared using ANOVA followed by post hoc pairwise multiple comparisons of means using Tukey contrasts.

All statistical analyses were performed using R (R Development Core Team, 2008). Reflection polarization characteristics in all setups were measured by imaging polarimetry using a Casio EX-ZR 101 camera and Polariwork 2.1 software (Estrato R&D Ltd., Budapest, Hungary) as described by Horváth and Varjú (1997).

The preference of mosquitoes was invariant of the position of the transillumination within a cage (WMPT; experiment 1, p=0.609; experiment 2, p=0.103; experiment 3, p=0.099; experiment 4, p=1). Gravid, but not non-gravid An. gambiae showed a preference for the dish containing clear water transilluminated by horizontally polarized light (FIG. 15). FIG. 15 shows the proportions of mosquitoes captured in shelters above Petri dishes transilluminated by horizontally polarized (dark boxes) and unpolarized light (clear boxes); the different lower case a on the box plot at the left marks the experiment in which a significantly higher proportion of mosquitoes was captured over the Petri dish transilluminated by horizontally polarized light. No preference was recorded for paraffin oil transilluminated by horizontally polarized light or for water transilluminated by horizontally polarized UV light (FIG. 15). A significantly higher portion (49.2%) of mosquitoes was trapped where gravid females were exposed to visible horizontally polarized light transilluminating clear water than by the other treatments (less than 26%; FIG. 15).

Gravid An. gambiae females but not non-gravid females are attracted to horizontally polarized light. Further, light polarization cues have an effect on gravid An. gambiae when provided in the visual range, but not when provided in the UV range as would be expected, since Ae. gambiae oviposits during night when UV illumination is negligible.

Presence of water vapour is indispensable to attract gravid female mosquitoes to sources of horizontally polarized light, since paraffin oil that closely mimics the water surface in its capacity to reflect horizontally polarized light did not induce attraction to Petri dishes.

What we record here in An. gambiae is a strong positive reaction to light polarization cues in contexts where such a response is adaptive to the hematophagous arthropod. The context, as we show here, can include resource-associated stimuli such as water vapour perceived by sensory organs other than eyes and the physiological state of the responding arthropod. Polarotactic behaviour in arthropods can be considered as a context-dependent reaction to light-polarization cues, but requiring multimodal sensory input to induce a behavioural response. Responses to light polarization cues in a particular context can be expected to serve as an asset for many hematophagous arthropods hitherto unstudied in this respect.

Further experiments (not shown here) were made using different forms of light polarization elements, which led to the conclusion, that the presence of a light polarizing element producing horizontally polarized light, which light polarizing element is at least partially curved is especially suitable for a device to capture and/or kill mosquitoes and other biting insects.

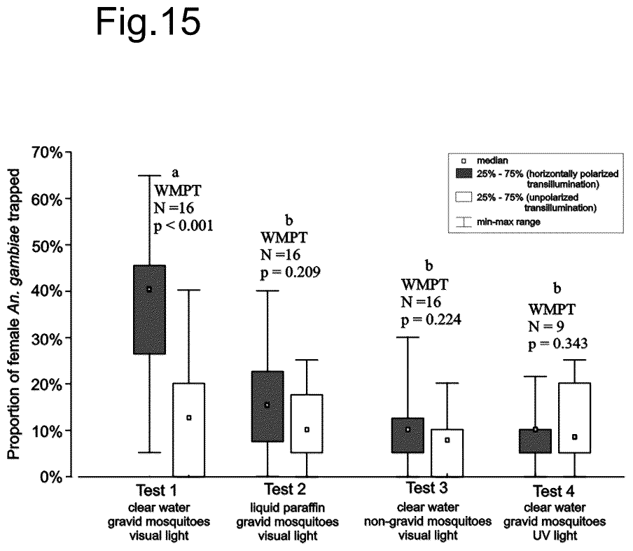

FIG. 16 shows a seventh embodiment of a device 1 according to the invention, which is based on the device 1 shown in FIG. 1. Only additional features of the device 1 are explained here.

The device 1 may additionally comprise an artificial light source 50, which artificial light source 50 directs light 51 onto the at least one solid light polarizing element 121.

This artificial light source 50 allows for the generation of horizontally polarized light by the at least one solid light polarizing element 121 especially in a situation where no or not enough natural light is provided. For example, the artificial light source 50 allows the generation and provision of horizontally polarized light by the at least one solid light polarizing element 121 at night, or when the device 1 is placed in a shadowed environment where not enough natural light reaches the at least one solid light polarizing element 121.

Thereby the device 1 is more apparent for insects that are attracted to horizontally polarized light, even under difficult light conditions and/or placement situations.

Preferentially, the device 1 comprises a power unit 52 providing electricity for the artificial light source 50.

Furthermore, the activation and/or inactivation of the artificial light source 50 might be controlled and/or regulated.

The device 1 might be provided with an ambient light sensor 53, which ambient light sensor 53 is coupled to a controller 54. The ambient light sensor 53 detects the amount of ambient light and provides this data to the controller 54. When the ambient light is below a defined threshold, the controller 54 generates a signal and the artificial light source 50 is switched on.

Furthermore, the controller 54 can comprise a clock programmed with information regarding the times of sunset.

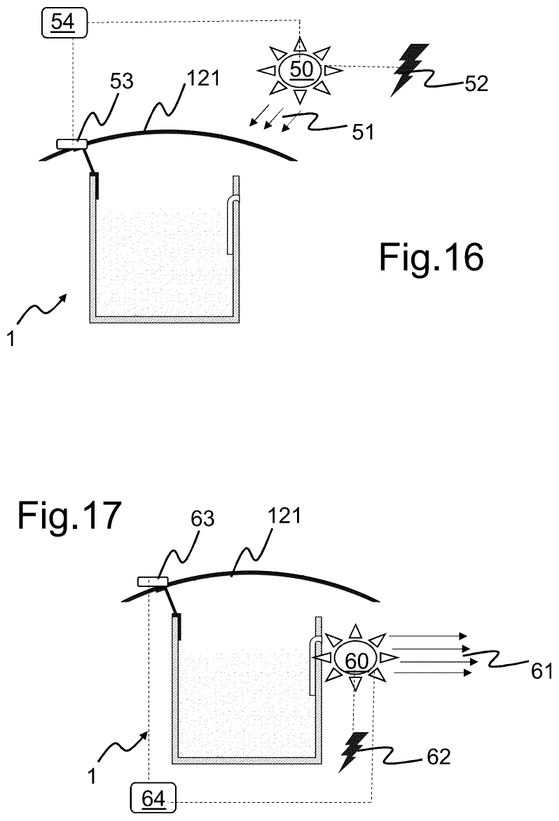

FIG. 17 shows an eight embodiment of a device 1 according to the invention, which is based on the device 1 shown in FIG. 1. Only additional features of the device 1 are explained here.

The device 1 comprises an artificial light source 60, which artificial light source provides horizontally polarized light 61, especially when no or not enough natural light is provided.

In this embodiment the artificial light source 60 is not required to direct the horizontally polarized light 61 onto the at least one solid light polarizing element 121.

According to an embodiment, the horizontally polarized light 61 provided by the artificial light source 60 is not directed onto the at least one solid light polarizing element 121 at all.

Preferentially, the device 1 comprises a power unit 62 providing electricity for the artificial light source 60. The power unit 62 might be a battery or a photovoltaic unit or any other suitable power source, especially any combination of said power sources. It is also possible to power the artificial light source 62 powered from a chemical reaction.

Furthermore, the activation and/or inactivation of the artificial light source 60 might be controlled and/or regulated.

The device 1 might be provided with an ambient light sensor 63 which is coupled to a controller 64. When the ambient light is below a defined threshold, the controller 64 generates a signal and the artificial light source 60 providing horizontally polarized light 61 is switched on.

It can be provided that the artificial light source 60 is automatically switched off after a predefined time interval. If after this time interval the ambient light sensor 63 detects that the amount of ambient light is too low for the at least one solid light polarizing element 121 to produce horizontally polarized light or to produce enough horizontally polarized light, the artificial light source 60 is switched on again.

Furthermore, switching on of the artificial light source 60 can be coupled to an inactivation of the ambient light sensor 63 and switching off of the artificial light source 60 can be coupled to an activation of the ambient light sensor 63.

Furthermore, the controller 64 can comprise a clock programmed with information regarding the times of sunset and sunrise. Especially, it may be provided, that the device does not rely on the ambient light sensor 63 but only on time data saved in a programme of the controller 64 The power unit 62, the ambient light sensor 63 and the controller 64 according to this embodiment might be the same, respectively, as the power unit 52, the ambient light sensor 53 and the controller 54 described for the embodiment shown in FIG. 16.

Although the figures generally refer to “schematic” representations and views, this does not mean that the figure representations and their description are of secondary importance with respect to the disclosure of the invention. The person skilled in the art is quite capable of obtaining enough information from the schematically and abstractly drawn representations to facilitate his understanding of the invention without being impaired in any way in his understanding, for example, by the drawn and possibly not exactly to scale size ratios of the container and/or parts of the device or other drawn elements. The figures thus enable the skilled person as a reader to derive a better understanding of the idea of the invention formulated in a more general and/or abstract manner in the claims as well as in the general part of the description on the basis of the more concretely explained embodiments of the device and method according to the invention and the more concretely explained mode of use of the container according to the invention.

1. A device to attract, capture and/or kill mosquitoes and other biting insects, comprising a container with a bottom surface, a side wall with an inner lateral surface and an outer lateral surface and with an upper rim, wherein the container is designed to release moisture, wherein said container is equipped with at least one solid light polarizing element producing horizontally polarized light, which at least one light polarizing element is at least partially curved, especially convex.

2. The device according to claim 1, wherein the at least one light polarizing element is designed in the form of a saucer dome, especially constituting a segment of a sphere.

3. The device according to claim 2, wherein the at least one light polarizing element is located above the upper rim of the container, especially wherein said light polarizing element protrudes over the upper rim of the container to cover an area bigger than the area circumscribed by said upper rim, preventing rain water from entering the device or wherein the at least one light polarizing element is held or anchored or sits freely on the bottom surface of the container, which container is at least partially filled with a liquid and wherein the at least one light polarizing element is partially immersed in the liquid within the container and which at least one light polarizing element partially protrudes above the upper rim of the container.

4. The device according claim 1, wherein an upper surface of the at least one solid light polarizing element is pierced with a hole or holes to vent air.

5. The device according to claim 1, wherein a solid light polarizing element is present on the inner lateral surface of the container and wherein another polarizing element is present on the outer lateral surface of the container, wherein said inner and outer polarizer elements may be portions of a single solid light polarizing material.

6. The device according to claim 1, wherein the at least one light polarizing element is formed from a sheet polarizer or formed of a specular reflector of dielectric non-liquid material, especially which light polarizing element reflects horizontally polarized light with a minimum degree of polarization of 20% and/or wherein the reflective surface of the at least one solid light polarizing element is a non-Lambertian surface.

7. The device according to claim 1, wherein the device contains a combination of at least two solid light polarizing elements chosen among dome-shaped polarizers, planar polarizers and polarizing portions of said container realized in any type of solid specular reflector of a dielectric non-liquid material that produces horizontally polarized light.

8. The device according to claim 1, wherein the container has a trapezoid form, a cylinder form, a square form or any combination of said forms, said form being defined in a plane that is perpendicular or set at any angle to said bottom surface of the container and/or wherein the container possesses at least one means which maintains and or stabilizes the level of liquid in said container, especially wherein the at least one means is formed as a hole in the container lateral wall or as a drain pipe.

9. The device according to claim 1, wherein the surface of the at least one solid light polarizing element is pierced by an opening serving as a non-return-entrance wherein said non-return-entrance is wide enough to allow mosquitoes and/or other biting insects to pass through said light polarizer element to reach its underside in a confined zone over the liquid or moisture emitter contained in the container.

10. The device according to claim 1, wherein any element of the device comprises insecticides selected from the group of contact insecticides, insecticide synergists, insect chemosterilants, insect growth regulators, surfactants, insect pathogens, parasites, GM symbionts or DNA vectors and/or chemical attractants for mosquitoes and/or biting insects, either alone or in any combination.

11. The device according to claim 1, wherein the device comprises an artificial light source, which artificial light source directs light onto the at least one solid light polarizing element.

12. The device according to claim 1, wherein the device comprises an artificial light source, which artificial light source provides horizontally polarized light.

13. A method for assembling and using a device for attracting, capturing and/or for killing mosquitoes and biting insects or for collecting the eggs of mosquitoes and biting insects, comprising the steps of:
a. providing a solid light polarizing element producing horizontally polarized light, which at least one light polarizing element is at least partially curved, especially convex;
b. providing a container;
c. arranging or incorporating said solid light polarizing element to said container to produce the maximum degree of polarization of reflected light;
d. positioning the device in a place, within which place said insects and/or insect eggs need to be collected and/or within which place said insects and/or insect eggs are killed;
e. providing a moisture emitter within the container.

14. The method according to claim 13, wherein the insects and/or insects' eggs captured and/or killed within the device are collected and counted.

15. Use of a device according to claim 1 to attract, capture and/or kill mosquitoes and other biting insects.
